(19) United States
(12) Patent Application Publication
(10) Pub. No.: US 2009/0030754 A1
(43) Pub. Date: Jan. 29, 2009

(54) METHODS, SYSTEMS AND COMPUTER SOFTWARE UTILIZING XBRL TO IDENTIFY, CAPTURE, ARRAY, MANAGE, TRANSMIT AND DISPLAY DOCUMENTS AND DATA IN LITIGATION PREPARATION, TRIAL AND REGULATORY FILINGS AND REGULATORY COMPLIANCE

(76) Inventor: Richard Timothy MCNAMAR, Falls Church, VA (US)

Correspondence Address: FOLEY AND LARDNER LLP;SUITE 500, 3000 K STREET NW, WASHINGTON, DC, 20007, US

(21) Appl. No.: 11/938,018

(22) Filed: Nov. 9, 2007

Related U.S. Application Data
(63) Continuation-in-part of application No. 11/740,122, filed on Apr. 25, 2007.
Application No. 11/740,122 is a continuation-in-part of application No. 11/740,616, filed on Apr. 26, 2007.
Application No. 11/740,616 is a continuation-in-part of application No. 11/790,487, filed on Apr. 25, 2007.
(60) Provisional application No. 60/957,094, filed on Aug. 21, 2007.
(60) Provisional application No. 60/794,533, filed on Apr. 25, 2006.
(60) Provisional application No. 60/794,821, filed on Apr. 26, 2006.
(60) Provisional application No. 60/794,822, filed on Apr. 26, 2006.
(60) Provisional application No. 60/794,834, filed on Apr. 26, 2006.
(60) Provisional application No. 60/794,835, filed on Apr. 26, 2006.
(60) Provisional application No. 60/794,836, filed on Apr. 26, 2006.
(60) Provisional application No. 60/794,838, filed on Apr. 26, 2006.
(60) Provisional application No. 60/794,858, filed on Apr. 26, 2006.
(60) Provisional application No. 60/841,529, filed on Sep. 1, 2006.
(60) Provisional application No. 60/844,674, filed on Sep. 15, 2006.
(60) Provisional application No. 60/845,777, filed on Sep. 20, 2006.
(60) Provisional application No. 60/908,050, filed on Mar. 26, 2007.
(60) Provisional application No. 60/794,821, filed on Apr. 26, 2006.
(60) Provisional application No. 60/794,822, filed on Apr. 26, 2006.
(60) Provisional application No. 60/794,834, filed on Apr. 26, 2006.
(60) Provisional application No. 60/794,835, filed on Apr. 26, 2006.
(60) Provisional application No. 60/794,836, filed on Apr. 26, 2006.
(60) Provisional application No. 60/794,838, filed on Apr. 26, 2006.
(60) Provisional application No. 60/794,858, filed on Apr. 26, 2006.
(60) Provisional application No. 60/841,529, filed on Sep. 1, 2006.
(60) Provisional application No. 60/844,674, filed on Sep. 15, 2006.
(60) Provisional application No. 60/845,777, filed on Sep. 20, 2006.
(60) Provisional application No. 60/908,050, filed on Mar. 26, 2007.
(60) Provisional application No. 60/794,533, filed on Apr. 25, 2006.
(60) Provisional application No. 60/794,821, filed on Apr. 26, 2006.
(60) Provisional application No. 60/794,835, filed on Apr. 26, 2006.
(60) Provisional application No. 60/794,838, filed on Apr. 26, 2006.
(60) Provisional application No. 60/794,836, filed on Apr. 26, 2006.
(60) Provisional application No. 60/794,858, filed on Apr. 26, 2006.
(60) Provisional application No. 60/794,822, filed on Apr. 26, 2006.
(60) Provisional application No. 60/794,834, filed on Apr. 26, 2006.
(60) Provisional application No. 60/841,529, filed on Sep. 1, 2006.
(60) Provisional application No. 60/844,674, filed on Sep. 15, 2006.
(60) Provisional application No. 60/845,777, filed on Sep. 20, 2006.
(60) Provisional application No. 60/908,050, filed on Mar. 26, 2007.

(51) Int. Cl. G06Q 10/00; G06F 7/20; G06Q 50/00; G06F 17/30

(52) U.S. Cl. 705/7; 707/4; 707/E17.008; 707/E17.014

(57) ABSTRACT

A method, system and program product for litigation and document management preparation and management, the method comprising: converting or having converted electronically using an XBRL taxonomy and metadata paper and/or electronic documents in various formats including XML/XBRL into XBRL formatted files and storing the XBRL formatted files in one or more repositories or receiving electronic access to such one or more repositories; receiving oral testimony electronic data; converting electronically the received oral testimony electronic data using an XBRL taxonomy and metadata into an oral testimony software file that is XBRL enabled; matching electronically one or more of people, dates, places, events, or documents in the oral testimony software file that is XBRL enabled to one or more of identical people, dates, places, events, or documents stored in the one or more repositories; and displaying, printing or otherwise communicating the matched one or more of people, dates, places, events, or document data items and one or more portions of documents in the one or more repositories that contain the matched data items.

### CROSS-REFERENCE TO RELATED PATENT APPLICATIONS

This application is a Continuation-In-Part of U.S. application Ser. No. 11/740,122, filed Apr. 25, 2007, incorporated herein by reference in its entirety, which claims priority from Provisional Application U.S. Application 60/794,533, filed Apr. 25, 2006, Provisional Application U.S. Application 60/794,821, filed Apr. 26, 2006, Provisional Application U.S. Application 60/794,834, filed Apr. 26, 2006, Provisional Application U.S. Application 60/794,836, filed Apr. 26, 2006, Provisional Application U.S. Application 60/794,835, filed Apr. 26, 2006, Provisional Application U.S. Application 60/794,858, filed Apr. 26, 2006, Provisional Application U.S. Application 60/794,822, filed Apr. 26, 2006, Provisional Application U.S. Application 60/794,838, filed Apr. 26, 2006, which claims priority from Provisional Application U.S. Application 60/841,529, filed Sep. 1, 2006, Provisional Application U.S. Application 60/844,674, filed Sep. 15, 2006, Provisional Application U.S. Application 60/845,777, filed Sep. 20, 2006, Provisional Application U.S. Application 60/908,050, filed Mar. 26, 2007, all of which applications are incorporated herein by reference in their entirety.

This application is also a Continuation-In-Part of U.S. application Ser. No. 11/740,616, filed Apr. 26, 2007, incorporated herein by reference in its entirety which claims priority from Provisional Application U.S. Application 60/794,533, filed Apr. 25, 2006, Provisional Application U.S. Application 60/794,821, filed Apr. 26, 2006, Provisional Application U.S. Application 60/794,834, filed Apr. 26, 2006, Provisional Application U.S. Application 60/794,836, filed Apr. 26, 2006, Provisional Application U.S. Application 60/794,835, filed Apr. 26, 2006, Provisional Application U.S. Application 60/794,858, filed Apr. 26, 2006, Provisional Application U.S. Application 60/794,822, filed Apr. 26, 2006, Provisional Application U.S. Application 60/794,838, filed Apr. 26, 2006, which claims priority from Provisional Application U.S. Application 60/841,529, filed Sep. 1, 2006, Provisional Application U.S. Application 60/844,674, filed Sep. 15, 2006, Provisional Application U.S. Application 60/845,777, filed Sep. 20, 2006, Provisional Application U.S. Application 60/908,050, filed Mar. 26, 2007, all of which applications are incorporated herein by reference in their entirety.

This application is also a Continuation-In-Part of U.S. application Ser. No. 11/790,487, filed Apr. 26, 2007, incorporated herein by reference in its entirety which claims priority from Provisional Application U.S. Application 60/794,533, filed Apr. 25, 2006, Provisional Application U.S. Application 60/794,821, filed Apr. 26, 2006, Provisional Application U.S. Application 60/794,834, filed Apr. 26, 2006, Provisional Application U.S. Application 60/794,836, filed Apr. 26, 2006, Provisional Application U.S. Application 60/794,835, filed Apr. 26, 2006, Provisional Application U.S. Application 60/794,858, filed Apr. 26, 2006, Provisional Application U.S. Application 60/794,822, filed Apr. 26, 2006, Provisional Application U.S. Application 60/794,838, filed Apr. 26, 2006, Provisional Application U.S. Application 60/841,529, filed Sep. 1, 2006, Provisional Application U.S. Application 60/844,674, filed Sep. 15, 2006, Provisional Application U.S. Application 60/845,777, filed Sep. 20, 2006, Provisional Application U.S. Application 60/908,050, filed Mar. 26, 2007, all of which applications are incorporated herein by reference in their entirety.

This application claims priority from Provisional Application U.S. Application 60/957,094, filed Aug. 21, 2007, incorporated herein by reference in its entirety.

### SUMMARY OF THE INVENTION

Briefly, in one embodiment, a litigation and document management computer-implemented method is disclosed, comprising: extracting and/or receiving or generating a plurality of records comprising at least litigation data and context data; creating or updating a plurality of XBRL records, each comprising XBRL data fields containing data made at a different time and associated metadata representing attributes at the data value level based on an information taxonomy, the creating or updating comprising converting the data into values in one or more of the XBRL data fields and creating from the context data metadata and associating the metadata representing attributes at the data value level based on forming links between and/or among at least two items selected from one or more of categories of the data fields, metadata and components associated with the data fields in the XBRL record; obtaining electronically data made over a period of time from one or more data fields in a plurality of the XBRL records; performing an algorithm electronically on the obtained data for the at least one of the data fields to obtain an algorithm calculation result; and communicating the algorithm calculation result.

In a further embodiment, computer-implemented method for document and litigation preparation and management is disclosed, comprising: receiving a search query; searching electronically, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search results; performing electronically a least one additional sort of the search results to obtain a sorted data array; and communicating the sorted data array.

In a yet further embodiment, a litigation and document management preparation and management method is disclosed, comprising: converting or having converted electronically using an XBRL taxonomy and metadata paper and/or electronic documents in various formats including XML/XBRL into XBRL formatted files and storing the XBRL formatted files in one or more repositories or receiving electronic access to such one or more repositories; receiving oral testimony electronic data; converting electronically the received oral testimony electronic data using an XBRL taxonomy and metadata into an oral testimony software file that is XBRL enabled; matching electronically one or more of people, dates, places, events, or documents in the oral testimony software file that is XBRL enabled to one or more of identical people, dates, places, events, or documents stored in the one or more repositories; and displaying, printing or otherwise communicating the matched one or more of people, dates, places, events, or document data items and one or more portions of documents in the one or more repositories that contain the matched data items.

In a yet further embodiment, the method comprises identifying discrepancies between metadata or linked data in the people, dates, places, events, or documents in the oral testimony software file that is XBRL enabled and the identical people, dates, places, events, or documents stored in the one or more repositories to thereby determine at least one discrepancy between the testimony and the data in the one or more repositories; and displaying, printing or otherwise communicating the matching one or more of people, dates, places, events, or documents and the identified discrepancies.

In a yet further embodiment, the matching step is performed substantially contemporaneously with the receiving the oral testimony electronic data step.

In a yet further embodiment, the matching one or more of people, dates, places, events, or documents and the identified discrepancies are printed and also stored electronically.

In a yet further embodiment, the matching step is performed between the oral testimony software file and deposition or earlier testimony data in the one or more repositories of the same witness.

In a yet further embodiment, the matching step is performed between the oral testimony software file and deposition or earlier testimony data in the one or more repositories of one or more different witnesses.

In a yet further embodiment, the displaying, printing or otherwise communicating comprises generating for one or more of a person, date, place, event, or document in the oral testimony software file a listing of each instance where the data item occurred across multiple witness data in the one or more repositories; and further comprising comparing discrepancies from multiple witnesses to identify the similarities and differences using the metadata from the XBRL files.

In a another embodiment, the method further comprises storing results of the comparing step and retrieving, transmitting, and displaying the comparisons.

In a further embodiment, a litigation and document management preparation and management system is disclosed, comprising: a storage medium; and at least one computer operably connected to the storage medium, and including the following components therein or among them if more than one: a component for converting or having converted electronically using an XBRL taxonomy and metadata paper and/or electronic documents in various formats including XML/XBRL into XBRL formatted files and storing the XBRL formatted files in one or more repositories or receiving electronic access to such one or more repositories; a component for receiving oral testimony electronic data; a component for converting electronically the received oral testimony electronic data using an XBRL taxonomy and metadata into an oral testimony software file that is XBRL enabled; a component for matching electronically one or more of people, dates, places, events, or documents in the oral testimony software file that is XBRL enabled to one or more of identical people, dates, places, events, or documents stored in the one or more repositories; and a component for displaying, printing or otherwise communicating the matched one or more of people, dates, places, events, or document data items and one or more portions of documents in the one or more repositories that contain the matched data items.

In a yet further embodiment, a litigation and document management preparation and management program product is disclosed, comprising: one or more computer usable media having computer readable program code embodied therein or among them, to be executed by a computer, the computer readable program code comprising program code for converting or having converted using an XBRL taxonomy and metadata paper and/or electronic documents in various formats including XML/XBRL into XBRL formatted files and storing the XBRL formatted files in one or more repositories or receiving electronic access to such one or more repositories; program code for receiving oral testimony electronic data; program code for converting the received oral testimony electronic data using an XBRL taxonomy and metadata into an oral testimony software file that is XBRL enabled; program code for matching one or more of people, dates, places, events, or documents in the oral testimony software file that is XBRL enabled to one or more of identical people, dates, places, events, or documents stored in the one or more repositories; and program code for displaying, printing or otherwise communicating the matched one or more of people, dates, places, events, or document data items and one or more portions of documents in the one or more repositories that contain the matched data items.

### BRIEF DESCRIPTION OF THE DRAWINGS

FIG. 1 is a schematic block diagram of an embodiment of the invention.

FIG. 2 is a schematic block diagram of a further embodiment of the invention.

### DETAILED DESCRIPTION OF THE PREFERRED EMBODIMENTS

The invention is web-based XBRL enhanced XML application software that is interoperable between multiple computer systems or repositories that may include distributed data bases and in some cases provides them functionality that they do not have without being interoperable. Utilizing the XML/XBRL interoperability feature, the application software is designed in one embodiment, to serve as middle-ware between different computer systems. The invention is able to accept and parse or search both XML based HTML documents and XBRL documents separately and also has the ability to convert XML documents to XBRL using various industry or functional taxonomies. Examples of such taxonomies are financial, shipping, healthcare, and the like. It can also accept and search ascii simple text, EML, or Microsoft HTML and other data using the TCP/IP transmission protocol or newer transmission protocols and languages from e-mail and text messaging, and instant messaging. These would include Voice over Internet Protocol (VOIP), video, and other streaming data feeds or data from social networks, e.g., Facebook. These can be searched separately or converted to XML or XBRL for storage, calculation, and comparisons of dates, events, places, individuals, or subject matter.

It should be noted that the term “XBRL” for purposes of this application, is given a special definition that encompasses not only XBRL, but also extensible Mark-up language equivalents that associate components representing attributes at the value level in a data field based on an information taxonomy, wherein a link or links are formed between and/or among at least two items selected from one or more of the categories of data fields, metadata, and components associated with the data fields, e.g., between two data field items, or between two metadata items, or between two component items, or between a data field item and an item of metadata, or between a data field item and a component item, or among both data fields and attributes. By way of example, attributes at the value level might relate to what the value represents, e.g., an “item of interest”, a current location point in time when a location of the “item of interest” was known, e.g., 4 μm in the afternoon, a date when a location of the “item of interest” was known, e.g., Feb. 2, 2006, person(s) or organization(s) in control of “item of interest,” to name a few.

XBRL provides metadata about each specific data field and content contained within a document by utilizing XBRL components. Thus XBRL enables components to be applied by data field at the most granular level, as opposed to enabling components to be applied at the document level with XML. XBRL can be implemented to be a standards-based vendor-independent technology.

XBRL files are defined by Metadata set out in Taxonomies. Taxonomies capture the definition of individual reporting elements as well as the relationships between elements within the taxonomy and in other taxonomies. A taxonomy may be a collection of XML schema documents. Subsequent extensions or adjustments to the taxonomies may be standardized. An XBRL component includes the resources necessary to implement a taxonomy for a data field, such as metadata, elements, tuples, linkbases, and stylesheets, to name a few. Schema defines items (data) and Tuples (concepts). Linkbases are a collection of links that arc concepts to resources. Style Sheets contain a page's semantic content and structure. For example, an XBRL Style Sheet relates to the rendering of text and data for communication. An Instance Document holds business facts, contexts, units, and references. For example, an individual's completed 1040 is like an XBRL Instance Document. Selected links would also be formed between and among the data fields and/or between and among metadata for the different data fields, and/or between and among each component (elements, tuples, metadata, and other resources) of the XBRL information taxonomy. These links could be formed by an XBRL conversion engine or at a later time by means of a subsequent linking operation or program.

A taxonomy for litigation data could be implemented, in one embodiment, by multiple government agencies or a consortium of experts designing a taxonomy for the values or ranges of values that would be measured for a given data field. Note that a customized taxonomy could be developed for each litigation. The taxonomy developers would typically also build in a plurality of conformance tests on each data item to insure that each data item entered/matched into a data field was within its appropriate data field parameter boundaries. These conformance tests would comprise the application of one or more business rules to specify what data could go into a data field and not accepting anything that does not meet these one or more rules. For example, if the data field is supposed to contain information regarding the date that the location of an “item of interest” was known in mm/dd/yyyy format, then the XBRL software will test and validate the incoming data to be sure the key punch operator or another data stream isn't entering a currency value in “dollars”.

Further, XBRL allows a robust method of expressing semantic meanings for its data fields, and the relationships between those data fields. This semantic meaning can be expressed by calculations to handle summations, formulas utilizing different data fields, and may also be obtained by a definition linkbase. Thus, another conformance test could include whether the data fields A, B and C, when utilized in a calculation such as A=B+C, give a result within certain limits. Thus, data is not just tested to ensure it meets specific formats, but also to ensure that the context of the data, both as a single data item and in relation to other data items, is correct as well.

Because it is the only data standard designed to work with all operating and application software, XBRL can tie together existing legacy systems in law firms, companies, agencies, and court stenographers. In many embodiments, no existing software need be replaced with new software just to obtain interoperability. All legacy software is mapped to work together using XBRL as a link or connector. In embodiments of the invention, an XBRL file is used to access data and metadata within an XBRL file and subject it to operations such as addition, subtraction, division, multiplication, or comparison with other data by a computer. This means that data from various databases, in differing formats, is now understandable to the computer and can be managed on the computer.

Using the present system, in one embodiment, data from multiple databases in differing formats can be accessed and analyzed. This is in contrast to a file pertaining to a “person of interest” in XML, which is essentially an HTML picture of the printed page designed to be viewed by humans, where the data contained in the file is inactive. That inactive data must be extracted, transferred, and entered into a new computer program. In one embodiment of the present system, XBRL software can monitor changes in data field values within the XBRL information record within the record's data field without removing it from the XML file. It is “Interactive.”

An exemplary system for implementing the overall system or portions of the invention include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Additionally, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed or received by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

It can be understood that the data being dealt with may be privileged information, and thus methods to secure the communication of data may be utilized. Specifically, encryption methods may be utilized in accordance with the invention to securely transfer data across logical connections to remote computers.

XBRL is interoperable with all known operating systems. It also operates with all application software identified to date. The amount of systems work and mapping needed depends on the entity's proprietary or legacy systems. Some information systems will take relatively little work to convert; others will be enormously expensive and difficult computer systems integrations work to convert to XBRL.

The invention, in one embodiment, is related specifically to an XBRL litigation system. The system can contain a plurality of data repositories, which may be distributed. These repositories includes a plurality of XBRL data bases and XML data bases that hold XBRL documents and other documents that could be converted into XBRL documents. Along with a plurality of data bases, these repositories are able to store the XBRL taxonomies and all of the components associated with the XBRL documents and data fields. One or more of these data repositories may store XBRL data bases, associated with different litigation entities, and may include private data bases. These XBRL data bases hold XBRL records with a plurality of XBRL data fields, with each data field having metadata and components that represent attributes at the data field value level. XBRL operates at the data level for alpha and numeric characters, with metadata related to the data field value level based on data according to an information taxonomy. The metadata may include all information pertinent to those data fields utilized in litigation databases.

As mentioned above, information from various sources, in various forms, will be mapped into XBRL data records, with one or more XBRL data fields in each XBRL record. Based on the data relating to the XBRL data fields and the values in those fields, metadata will be created representing attributes at the data field level based on an information taxonomy and associating the metadata with the data field. The term “associating” is intended to encompass the act of electronically linking.

This conversion into an XBRL or equivalent data record is accomplished by a conversion engine, which operates to take each of a plurality of items of data from a data record and map it or otherwise electronically transfer it into a data field or fields in the XBRL data record and validate the data against an information taxonomy. The conversion engine further converts context data and other data associated with the data value into metadata. For example, for a field of person with a value “John Doe,” there would be associated with that value in the data field a plurality of metadata identifying a given location, address, nationality, regional affiliation, to name a few. In one embodiment, the conversion engine could also form selected links between and/or among other data fields and/or between and among metadata for the different data fields, and/or between and among components (elements, tuples, metadata, and other resources) of the XBRL information taxonomy. Alternatively, these links could be formed at a later time by means of a linking program.

More specifically, in one embodiment, the invention comprises an Extensible Business Reporting Language (“XBRL”) or its underlying technology used with other industry or specialized taxonomies based software application that electronically searches for relevant documents and data and relates them, in one embodiment, in preparation for litigation or for regulatory compliance filings management. Over the web, the XBRL application software will automatically identify, array, and link not only the documents, but also can be used to do the same with the data within a document, to other documents and the data in other documents. Using a combination of XBRL linkbase, Boolean algebra search capabilities, and Google One Box, and ask.com technologies, the invention has a unique three faceted capability to search and relate documents by pre-determined criteria, e.g., author, date, subject matter, etc. Using XBRL's unique capability to interoperate as middle ware and interact or map to all other software languages or document standards, the invention has unprecedented capabilities in the electronic discovery and document management areas.

Given its capabilities XBRL software can provide a company with the ability to obtain through discovery and relate native paper or native electronic documents and data within its files or within an opposing party's files in litigation. The native paper documents can be optically screened into an XBRL format such as by categorizing each noun in the document or testimony against a taxonomy, which may in some cases entail creating new categories in the taxonomy for unmatched data items, then transmitting to a server and inputting into an electronic database. For electronically native documents such as Word, Word Perfect or Corel documents, Excel spreadsheets, and e-mails from Microsoft, Lotus Notes, and Firefox e-mail generators, as well open source document management software, e.g. Linux, the XBRL software can access Microsoft Outlook address books and related information management files, plus Power Point and Share Point meeting software and convert them to XBRL files. While other computer software applications can provide access to these electronic records at the document level, only XBRL can provide the interaction at both the document and data level and can relate the two documents, one by document level and the other at the document's data level.

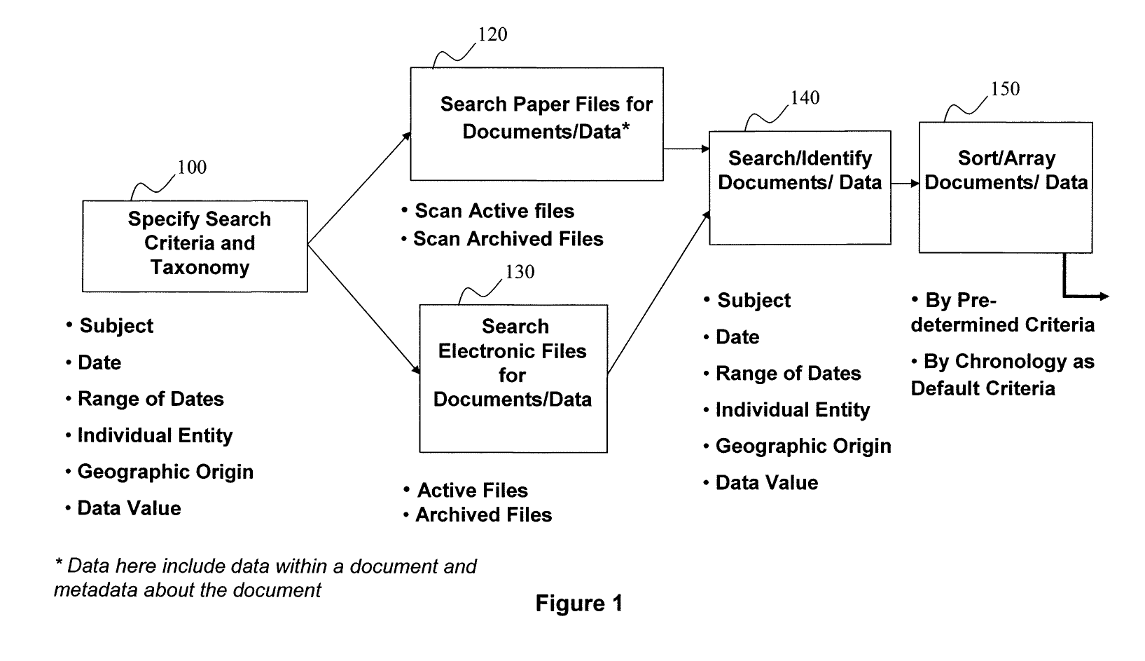

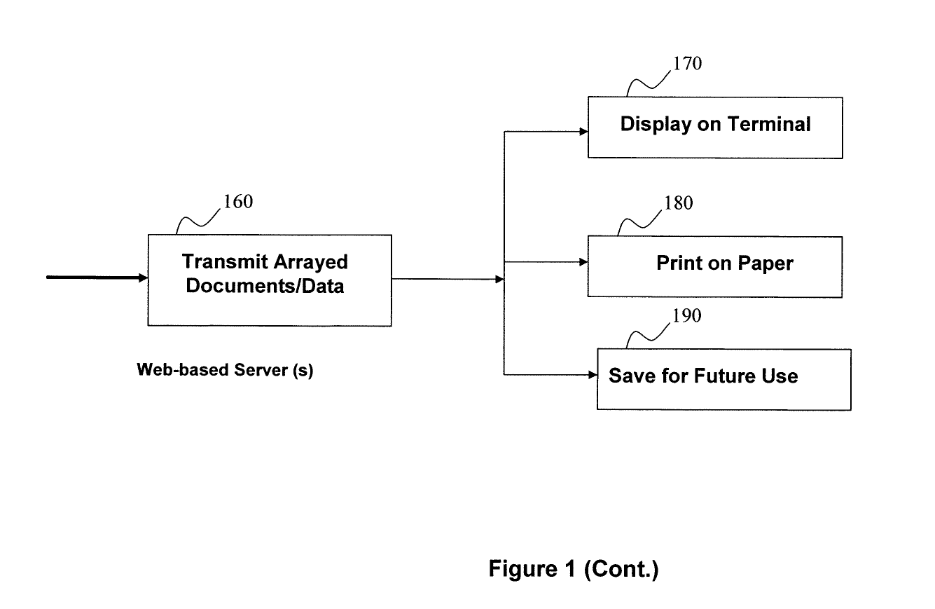

Embodiments of the present software can array and display the relevant data in any number of pre-determined formats or a format chosen by the user at the time. The data related to a given data item category may be transmitted for display and storage or viewing by computer screen or printed out in hard copy at any remote location for viewing. (See FIG. 1.)

Referring in more detail to FIG. 1, in one embodiment, search criteria and one or more taxonomies are specified to be used for data, as represented by block 100. Then the software is used to electronically search, as represented by blocks 120 and 130, all available documents in an enterprise's electronic database by subject for a pre-determined time period. This includes both documents that are electronic native (originally created in an electronic form and converted where necessary to XBRL format, see block 130) and documents that are paper native and subsequently converted into an electronic form and XBRL format in the database, as represented by block 120.

In one embodiment, these documents are searched based on specified search terms, for example, by subject, date, range of dates, individual identity, geography, and data value) in block 140 and extracted and arrayed as represented by block 150, according to a pre-determined format. If no pre-determined format is specified, they are arrayed chronologically from the oldest to the most recent. After the documents are arrayed, in one embodiments the software can then perform additional sorting, such as by type of document, e.g., e-mails, memos, meeting notes, etc. After the documents are arrayed, the software can then perform additional sorting, such as the author, the corporate division, the geographic origin of the document, etc. This array and any additional sorting or ranking of documents is transmitted to a server as represented by block 160, and then to a terminal, as represented by block 170 where it may be displayed and viewed remotely, and/or it may be printed, as represented by block 180, and/or it may be placed in electronic storage, as represented by block 190.

In another embodiment, the software of the invention is used to search all available documents in an enterprise's electronic database by author for a pre-determined time period. This includes both documents that are electronic native (originally created in an electronic form) and documents that are paper native and subsequently converted into an electronic form.

These documents are identified and extracted and arrayed according to a pre-determined format. If a pre-determined format is not specified, they are arrayed chronologically from the oldest to the most recent. After the documents are arrayed, the software can then perform additional sorting, such as by type of document, e.g., e-mails, memos, meeting notes, etc. After the documents are arrayed, the software can then perform additional sorting of the documents, such as the author, the corporate division, the geographic origin of the document, etc. This array and any additional sorting or ranking of documents is transmitted to a server, then to terminal where it may be displayed and viewed remotely or it may be printed. In another embodiment, the software is used to search all available documents in an electronic database by location (corporate department or geographic location) for a pre-determined time period. This includes both documents that are electronic native (originally created in an electronic form) and documents that are paper native and subsequently converted into an electronic form. These documents are identified and extracted and arrayed according to a pre-determined format. If no pre-determined format is specified, they are arrayed chronologically from the oldest to the most recent. After the documents are arrayed, the software can then perform additional sorting of the documents, such as by type of document, e.g., e-mails, memos, meeting notes, etc. After the documents are arrayed, the software can then perform additional sorting of the documents, such as the author, the corporate division, the geographic origin of the document, etc. This array and any additional sorting or ranking of documents is transmitted to a server, then to terminal where it may be displayed and viewed remotely or it may be printed.

In another embodiment, the software is used to search all available documents in an electronic data base by data instance, e.g., the number “12” for a pre-determined time period. This includes data from documents that are electronic native (originally created in an electronic form) and data from documents that are paper native and subsequently converted into an electronic form. Once the data is identified, the document containing it is extracted and arrayed according to a pre-determined format. If no pre-determined format is specified, the data are arrayed chronologically from the oldest to the most recent. After the data and documents are arrayed, the software can then perform additional sorting of the documents, such as by type of document, e.g., e-mails, memos, meeting notes, etc. After the data and documents are arrayed, the software can then perform additional sorting of the documents, such as the author, the corporate division, the geographic origin of the document, e.g., “all employees who used the data 12 in location A, between Jan. 1, 19XX and Sep. 10, 20XX. This array and any additional sorting or ranking of documents is transmitted to a server, then to a terminal where it may be displayed and viewed remotely or it may be printed.

In another embodiment, the software will interoperate with other software to identify, array, link, and transmit documents and data and relate them. For example, the software will work with Google One Box to search all data and documents within an enterprise to identify and relate it by pre-determined criteria. The software will also interoperate with other existing software with to search e-mail or instant text messaging files for Mac, Microsoft office, Google, Foxfire, and other e-mail sources. These documents and data are identified and extracted and arrayed according to a pre-determined format. If no pre-determined format is specified, they are arrayed chronologically from the oldest to the most recent. After the documents are arrayed, the software can then perform additional sorting of the documents, such as by type of document, e.g., e-mails, memos, meeting notes, etc. After the documents are arrayed, the software can then perform additional sorting of the documents, such as the author, the corporate division, the geographic origin of the document, etc. This array and any additional sorting or ranking of documents is transmitted to a server, then to a terminal where it may be displayed and viewed remotely or it may be printed.

In another embodiment, the litigation support XBRL software will be able to accept a digital data feed from a court stenographer during a deposition or trial, convert that feed into XBRL format, and use a Boolean search to compare contemporaneously the testimony with previously stored documents. This would include being able to accept an XBRL data feed directly from the court stenographer. Note that in one embodiment, the conversion would comprise electronically categorizing each noun in the transcript against a litigation taxonomy, and then electronically comparing the categorized noun against other entries from that category. This will permit an attorney conducting the deposition to refresh contemporaneously the memory of a friendly witness by helping them to recall e-mails sent or received, documents written or received, or other data relating to dates, events, and places relevant to their testimony. Similarly, the attorney will be able contemporaneously to identify inconsistencies in an adverse witness's oral testimony and previous e-mails sent or received, documents written or received, and other data relating to dates, events, and places relevant to their testimony. The attorney can either contemporaneously correct or impeach the creditability of the adverse witness during the deposition or have the option of point out the adverse witness's inconsistencies later in trial or during settlement negotiations.

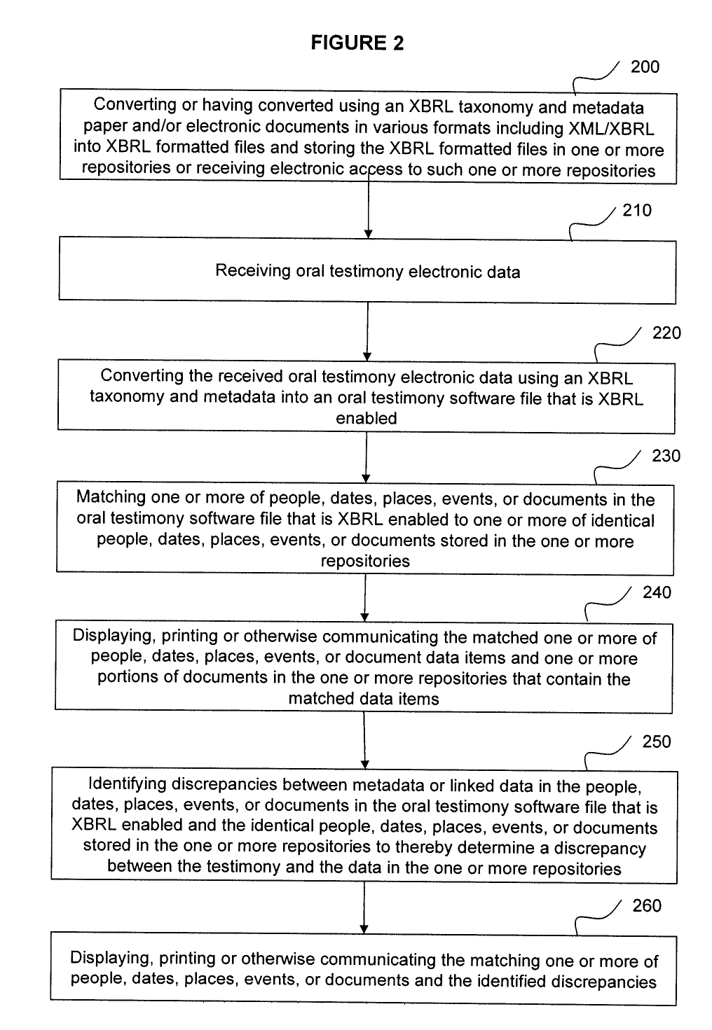

Referring to FIG. 2, an embodiment of a computer-implemented litigation and document management preparation and management method is disclosed. Referring to block 200, a step is provided of converting or having converted using an XBRL taxonomy and metadata paper and/or electronic documents in one or more formats including XML/XBRL into XBRL formatted files and storing the XBRL formatted files in one or more repositories or receiving electronic access to such one or more repositories. Note that this step could be implemented by contracting out the electronic conversion of litigation documents comprising categorizing each noun in the document against a litigation taxonomy, and creating links to the noun to various other pertinent nouns, or facts related to the noun. Alternatively, this step could be implemented by simply receiving electronic access to such a repository of converted litigation documents.

Referring to block 210, a step is provided of receiving oral testimony electronic data. In one embodiment, this might comprise receiving an electronic data feed from a stenographic transcribing machine.

Referring to block 220, a step is provided of converting the received oral testimony electronic data using an XBRL taxonomy and metadata into an oral testimony software file that is XBRL enabled. In one embodiment, this would comprise electronically categorizing each noun in the oral testimony electronic data transcript against a litigation taxonomy and adding links as set forth in the taxonomy.

Referring to block 230, a step is provided of matching one or more of people, dates, places, events, or documents in the oral testimony software file that is XBRL enabled to one or more of identical people, dates, places, events, or documents stored in the one or more repositories. In one embodiment, the matching step could comprise electronically comparing the categorized noun against other entries from that category in the one or more repositories. In one implementation, the comparison could be performed substantially contemporaneously with the receiving the oral testimony electronic data from an electronic feed from a stenographic machine.

Referring to block 240, the step is provided of displaying, printing or otherwise communicating the matched one or more of people, dates, places, events, or document data items and one or more portions of documents in the one or more repositories that contain the matched data items. In one embodiment, this matched data is stored in the one or more repositories. In a further embodiment, text may be displayed or printed or otherwise communicated in adjacency to the matched data.

In a yet further embodiment, a step represented by block 250 is provided of identifying discrepancies between metadata or linked data in the people, dates, places, events, or documents in the oral testimony software file that is XBRL enabled and the identical people, dates, places, events, or documents stored in the one or more repositories to thereby determine at least one discrepancy between the testimony and the data in the one or more repositories.

Referring to block 260, the step is provided of displaying, printing or otherwise communicating the matching one or more of people, dates, places, events, or documents and the identified discrepancies.

In one embodiment, the matching step of block 230 is performed between the oral testimony software file and deposition or earlier testimony data in the one or more repositories of the same witness.

In a further embodiment, the matching step is performed between the oral testimony software file and deposition or earlier testimony data in the one or more repositories of one or more different witnesses.

In a yet further embodiment, the displaying, printing or otherwise communicating step of block 240 comprises generating for one or more of a person, date, place, event, or document in the oral testimony software file a listing of each instance where the data item occurred across multiple witness data in the one or more repositories and then comparing discrepancies from multiple witnesses to identify the similarities and differences using the metadata from the XBRL files.

In another embodiment, the software is used to manage, search, and control regulatory filings. This includes filings with environmental, energy, health and safety agencies where approvals are necessary. Both the entity filing the required information and the government agency in charge of the approval process can use the software to identify documents and data by date, subject matter, author, entity, and relate the documents or data to other filings or independent information outside the regulatory filing. The software can relate the documents in the regulatory filings by subject to documents or data outside the regulatory filings and array them by date, subject, entity, organization, etc.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A litigation and document management computer-implemented method, comprising:
extracting and/or receiving or generating a plurality of records comprising at least litigation data and context data;
creating or updating a plurality of XBRL records, each comprising XBRL data fields containing data made at a different time and associated metadata representing attributes at the data value level based on an information taxonomy, the creating or updating comprising converting the data into values in one or more of the XBRL data fields and creating from the context data metadata and associating the metadata representing attributes at the data value level based on forming links between and/or among at least two items selected from one or more of categories of the data fields, metadata and components associated with the data fields in the XBRL record;
obtaining electronically data made over a period of time from one or more data fields in a plurality of the XBRL records;
performing an algorithm electronically on the obtained data for the at least one of the data fields to obtain an algorithm calculation result; and
communicating the algorithm calculation result.

2. A computer-implemented method for document and litigation preparation and management, comprising:
receiving a search query;
searching electronically, using the search query, a plurality of XBRL data fields in records in a plurality of different data repositories, with each of the XBRL data fields having metadata representing attributes at the data value level based on context data according to an information taxonomy, and with links formed between and/or among at least two items selected from one or more of the categories of data fields, metadata, and components associated with the data fields, the searching obtaining a search results;
performing electronically a least one additional sort of the search results to obtain a sorted data array; and
communicating the sorted data array.

3. A litigation and document management preparation and management method, comprising:
converting or having converted electronically using an XBRL taxonomy and metadata paper and/or electronic documents in various formats including XML/XBRL into XBRL formatted files and storing the XBRL formatted files in one or more repositories or receiving electronic access to such one or more repositories;
receiving oral testimony electronic data;
converting electronically the received oral testimony electronic data using an XBRL taxonomy and metadata into an oral testimony software file that is XBRL enabled;
matching electronically one or more of people, dates, places, events, or documents in the oral testimony software file that is XBRL enabled to one or more of identical people, dates, places, events, or documents stored in the one or more repositories; and
displaying, printing or otherwise communicating the matched one or more of people, dates, places, events, or document data items and one or more portions of documents in the one or more repositories that contain the matched data items.

4. The method as defined in claim 3, further comprising identifying discrepancies between metadata or linked data in the people, dates, places, events, or documents in the oral testimony software file that is XBRL enabled and the identical people, dates, places, events, or documents stored in the one or more repositories to thereby determine at least one discrepancy between the testimony and the data in the one or more repositories; and
displaying, printing or otherwise communicating the matching one or more of people, dates, places, events, or documents and the identified discrepancies.

5. The method as defined in claim 3, wherein the matching step is performed substantially contemporaneously with the receiving the oral testimony electronic data step.

6. The method as defined in claim 3, wherein the matching one or more of people, dates, places, events, or documents and the identified discrepancies are printed and also stored electronically.

7. The method as defined in claim 3, wherein the matching step is performed between the oral testimony software file and deposition or earlier testimony data in the one or more repositories of the same witness.

8. The method as defined in claim 3, wherein the matching step is performed between the oral testimony software file and deposition or earlier testimony data in the one or more repositories of one or more different witnesses.

9. The method as defined in claim 3, wherein the displaying, printing or otherwise communicating comprises generating for one or more of a person, date, place, event, or document in the oral testimony software file a listing of each instance where the data item occurred across multiple witness data in the one or more repositories; and
comparing discrepancies from multiple witnesses to identify the similarities and differences using the metadata from the XBRL files.

10. The method as defined in claim 3, further comprising storing results of the comparing step and retrieving, transmitting, and displaying the comparisons.

11. A litigation and document management preparation and management system, comprising:
a storage medium; and
at least one computer operably connected to the storage medium, and including the following components therein or among them if more than one:
a component for converting or having converted electronically using an XBRL taxonomy and metadata paper and/or electronic documents in various formats including XML/XBRL into XBRL formatted files and storing the XBRL formatted files in one or more repositories or receiving electronic access to such one or more repositories;
a component for receiving oral testimony electronic data;
a component for converting electronically the received oral testimony electronic data using an XBRL taxonomy and metadata into an oral testimony software file that is XBRL enabled;
a component for matching electronically one or more of people, dates, places, events, or documents in the oral testimony software file that is XBRL enabled to one or more of identical people, dates, places, events, or documents stored in the one or more repositories; and
a component for displaying, printing or otherwise communicating the matched one or more of people, dates, places, events, or document data items and one or more portions of documents in the one or more repositories that contain the matched data items.

12. A litigation and document management preparation and management program product, comprising:
one or more computer usable media having computer readable program code embodied therein or among them, to be executed by a computer, the computer readable program code comprising
program code for converting or having converted using an XBRL taxonomy and metadata paper and/or electronic documents in various formats including XML/XBRL into XBRL formatted files and storing the XBRL formatted files in one or more repositories or receiving electronic access to such one or more repositories;
program code for receiving oral testimony electronic data;
program code for converting the received oral testimony electronic data using an XBRL taxonomy and metadata into an oral testimony software file that is XBRL enabled;
program code for matching one or more of people, dates, places, events, or documents in the oral testimony software file that is XBRL enabled to one or more of identical people, dates, places, events, or documents stored in the one or more repositories; and
program code for displaying, printing or otherwise communicating the matched one or more of people, dates, places, events, or document data items and one or more portions of documents in the one or more repositories that contain the matched data items.
